(19) United States
(12) Patent Application Publication
(10) Pub. No.: US 2025/0106593 A1
(43) Pub. Date: Mar. 27, 2025

(54) UE COMMUNICATION CONTROL METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Yang SHEN, Beijing (CN); Xiaolong LI, Beijing (CN)

(21) Appl. No.: 18/729,104

(22) PCT Filed: Jan. 17, 2022
(86) PCT No.: PCT/CN2022/072386

§ 371 Date: Jul. 15, 2024

(51) Int. Cl. H04W 4/029

(52) U.S. Cl. CPC H04W 4/029

(57) ABSTRACT

A UE communication control method includes: receiving mobility restriction information and geographical area information of a tracking area (TA) from a network device; determining position information of a position where UE is located; and controlling a communication between the UE and the network device according to the position information of the UE, the mobility restriction information, and the geographical area information of the TA.

### CROSS-REFERENCE TO RELATED APPLICATION

The present application is a U.S. National Stage of International Application No. PCT/CN2022/072386, filed on Jan. 17, 2022, the contents of all of which are incorporated herein by reference in their entireties for all purposes.

### BACKGROUND OF THE INVENTION

Mobility restrictions are used for restricting mobility of user equipment (UE) or restricting access services. The mobility restrictions include a radio access technology (RAT) restriction, a forbidden area (FA), a service area restriction (SAR), a core network type restriction, etc.

### SUMMARY OF THE INVENTION

The disclosure relates to, but is not limited to, the field of wireless communications, in particular to a UE communication control method and apparatus, a communication device, and a storage medium.

A first aspect of an example of the disclosure provides a UE communication control method, performed by user equipment (UE) and including: receiving mobility restriction information and geographical area information of a tracking area (TA) from a network device; determining position information of a position where the UE is located; and controlling a communication between the UE and the network device according to the position information of the UE, the mobility restriction information, and the geographical area information of the TA.

A second aspect of an example of the disclosure provides a UE communication control method, performed by a network device and including: transmitting mobility restriction information and geographical area information of a tracking area (TA) to user equipment (UE), where the mobility restriction information and the geographical area information of the TA is used for controlling a communication between the UE and the network device.

A third aspect of an example of the disclosure provides a UE communication control apparatus, including: a first receiving module, configured to receive mobility restriction information and geographical area information of a tracking area (TA) from a network device; a first determining module, configured to determine position information of a position where the UE is located; and a control module, configured to control a communication between the UE and the network device according to the position information of the UE, the mobility restriction information, and the geographical area information of the TA.

A fourth aspect of an example of the disclosure provides a UE communication control apparatus, including: a second transmitting module, configured to transmit mobility restriction information and geographical area information of a tracking area (TA) to user equipment (UE), where the mobility restriction information and the geographical area information of the TA is used for controlling a communication between the UE and a network device.

A fifth aspect of an example of the disclosure provides a communication device, including a processor, a transceiver, a memory and an executable program stored on the memory and capable of being run by the processor, where the processor, when running the executable program, performs the UE communication control method according to the first aspect or the second aspect of the disclosure.

A sixth aspect of an example of the disclosure provides a non-transitory computer storage medium, the non-transitory computer storage medium storing an executable program; and the executable program being capable of, when executed by a processor, implementing the UE communication control method according to the first aspect or the second aspect of the disclosure.

### BRIEF DESCRIPTION OF DRAWINGS

Accompanying drawings, which are incorporated in and constitute a part of the specification, illustrate examples consistent with the disclosure and, together with the specification, serve to explain principles of the examples of the disclosure.

FIG. 1 is a schematic structural diagram of a wireless communication system according to an example.

FIG. 2 is a schematic diagram of TA coverage and a position where UE is located according to an example.

FIG. 3 is a schematic flowchart of a UE communication control method according to an example.

FIG. 4 is a schematic flowchart of a UE communication control method according to an example.

FIG. 5 is a schematic flowchart of a UE communication control method according to an example.

FIG. 6 is a schematic flowchart of a UE communication control method according to an example.

FIG. 7 is a schematic flowchart of a UE communication control method according to an example.

FIG. 8 is a schematic flowchart of a UE communication control method according to an example.

FIG. 9 is a schematic flowchart of a UE communication control method according to an example.

FIG. 10 is a schematic flowchart of a UE communication control method according to an example.

FIG. 11 is a schematic structural diagram of a UE communication control apparatus according to an example.

FIG. 12 is a schematic structural diagram of a UE communication control apparatus according to an example.

FIG. 13 is a schematic structural diagram of UE according to an example.

FIG. 14 is a schematic structural diagram of a communication device according to an example.

### DETAILED DESCRIPTION OF THE INVENTION

The examples will be described in detail, and their instances are represented in the accompanying drawings. Unless otherwise indicated, when the following description refers to the accompanying drawings, the same number in different accompanying drawings represents the same or similar elements. Embodiments described in the following examples do not represent all embodiments consistent with the examples of the disclosure. Rather, they are merely examples of an apparatus and method consistent with some aspects of the examples of the disclosure as detailed in appended claims.

Terms used in the examples of the disclosure are intended to describe specific embodiments but not to limit the examples of the disclosure. A singular form “a/an”, “said” and “the” used in the examples and the appended claims of the disclosure is also intended to include a plural form unless other meanings are indicated clearly in the context. It is to be further understood that a term “and/or” used in the disclosure refers to and contains any one or all possible combinations of one or a plurality of associated listed items.

It is to be understood that various information, possibly described by using terms such as first, second and third in the examples of the disclosure, is not limited to these terms. These terms are used for distinguishing the same type of information. For example, without departing from the scope of the examples of the disclosure, first information may also be called second information, and similarly, the second information may also be called the first information. Depending on the context, words such as “if” and “in a case that” used in the disclosure may be construed as “when . . . ”, or “while . . . ” or “in response to determining”.

Please refer to FIG. 1, which shows a schematic structural diagram of a wireless communication system according to an example of the disclosure. As shown in FIG. 1, the wireless communication system 10 is a communication system based on a cellular mobile communication technology. The wireless communication system 10 may include a plurality of UE 11 and a plurality of access devices 12.

The UE 11 may refer to a device providing at least one of speech or data connectivity for a user. The UE 11 may communicate with one or a plurality of core networks via a radio access network (RAN). The UE 11 may be an Internet of Things UE (for example, a sensor device), a mobile phone (or called “cellular” phone) and a computer with the Internet of Things UE, for example, may be a fixed, portable, pocket, hand-held, built-in-computer or vehicle-mounted apparatus. For example, the UE 11 may be a station (STA), a subscriber unit, a subscriber station, a mobile station, a mobile, a remote station, an access point, remote UE (remote terminal), access UE (access terminal), a user terminal, a user agent, a user device, or user equipment (UE). Alternatively the UE 11 may also be a device of an unmanned aerial vehicle. Alternatively the UE 11 may also be a vehicle-mounted device, for example, may be a trip computer with a wireless communication function, or a wireless communication device externally connected with the trip computer. Alternatively the UE 11 may also be a road-side unit, for example, may be a street lamp, a signal lamp, or other road-side units with a wireless communication function.

The access device 12 may be a network device in a wireless communication system. The wireless communication system may be the 4^{th} generation mobile communication (4G) system, also called a long term evolution (LTE) system. Alternatively the wireless communication system may also be a 5G system, also called a new radio (NR) system or a 5G NR system. Alternatively the wireless communication system may also be a next generation system of the 5G system. An access network in the 5G system may be called a new generation-radio access network (NG-RAN). Alternatively the wireless communication system may be a Machine Type Communication (MTC) system.

The access device 12 may be an evolved access device (eNB) adopted in the 4G system. Alternatively the access device 12 may also be an access device adopting a centralized-distributed architecture (gNB) in the 5G system. In a case of adopting the centralized-distributed architecture, the access device 12 generally includes a central unit (CU) and at least two distributed units (DU). A protocol stack of a packet data convergence protocol (PDCP) layer, a radio link control (RLC) layer, a media access control (MAC) layer is arranged in the central unit. A protocol stack of a physical (PHY) layer is arranged in the distributed unit. A specific embodiment of the access device 12 is not limited by the example of the disclosure.

A wireless connection may be established between the access device 12 and the UE 11 through a wireless radio. In different embodiments, the wireless radio is a wireless radio based on a 4^{th} generation mobile communication network technology (4G) standard. Alternatively the wireless radio is a wireless radio based on a 5^{th} generation mobile communication network technology (5G) standard, for example, the wireless radio is a new radio. Alternatively the wireless radio may also be a wireless radio based on a next generation mobile communication network technology standard of 5G.

In some examples, an end to end (E2E) connection may also be established between the UEs 11, for example, vehicle to vehicle (V2V) communication, vehicle to Infrastructure (V2I) communication and vehicle to pedestrian (V2P) communication and other scenes in vehicle to everything (V2X).

In some examples, the wireless communication system 10 may further include a network management device 13.

The plurality of access devices 12 are connected with the network management device 13 respectively. The network management device 13 may be a core network device in the wireless communication system 10, for example, the network management device 13 may be a mobility management entity (MME) in an evolved packet core (EPC). Alternatively the network management device may also be another core network device, for example, a serving gateway (SGW), a public data network gateway (PGW), a policy and charging rules function (PCRF), a home subscriber server (HSS) or the like. The example of the disclosure does not limit an embodiment form of the network management device 13.

The UE accesses to a network through a terrestrial cellular system, and a wireless cell usually broadcasts a tracking area identification (TAI) of a single tracking area (TA) to the UE. The UE accesses to a network through a satellite, and due to a height of the satellite, a beam coverage range and other factors, a satellite cell supports broadcasting TAI of single TA or TAIs of a plurality of TAs to the UE.

However, under a satellite access scene, in order to implement efficient paging for the UE and at least one of FA control or SAR control over the UE, gNB needs to transmit the broadcast TAI to an access management function (AMF) through an NG Application Protocol (NGAP) message. TA information may include the TAI indicating the TA.

Meanwhile, in a case that the gNB can obtain TA information corresponding to a position where the UE is located, the gNB further reports to the AMF a TAI of a TA where the UE is located currently. The AMF establishes a registration area (RA) for the UE according to the broadcast TAI and the TA where the UE is located currently, and the AMF implements at least one of FA control or SAR control over the UE in combination with at least one of subscription information or a local policy of the UE.

Processes for implementing at least one of the FA control or the SAR control over the UE may be as follows respectively.

The FA control is as follows.

A single TAI or a plurality of TAIs is/are broadcast, and the FA control is based on the subscription information of the UE.

In a case that the single TAI is broadcast and it is determined based on the subscription information of the UE that the single TAI is included in TAs indicated by FA information, the AMF refuses the UE to access to the network.

In a case that the plurality of TAIs are broadcast and it is determined based on the subscription information of the UE that the plurality of TAIs are all in the FA information, the AMF refuses the UE to access to the network.

In a case that the AMF refuses the UE to access to the network, the UE cannot perform any communication with the network in the TA indicated by the FA information.

In a case that at least one of the broadcast TAIs is not included in the FA information, the UE may communicate with the network.

The SAR control is as follows.

In a case that none of broadcast TAIs are included in an allowable area indicated by SAR information, it is determined that the UE is located in a non-allowable area, and none of service communications can be initiated between the UE and the network. In a case that at least one of the broadcast TAIs is included in the allowable area, it is determined that the UE is located in the allowable area and may perform any communication with the network.

The processes of the above-mentioned FA control and/or SAR control are judged depending merely on the broadcast TAIs. However, the TAIs reported to the network (AMF) further include a TAI representing the position where the UE is located currently besides the broadcast TAIs. The TAI representing the position where the UE is located currently is a TAI obtained by mapping and converting by the gNB according to the position information of the position where the UE is located actually. This TAI actually may be not included in the broadcast TAIs.

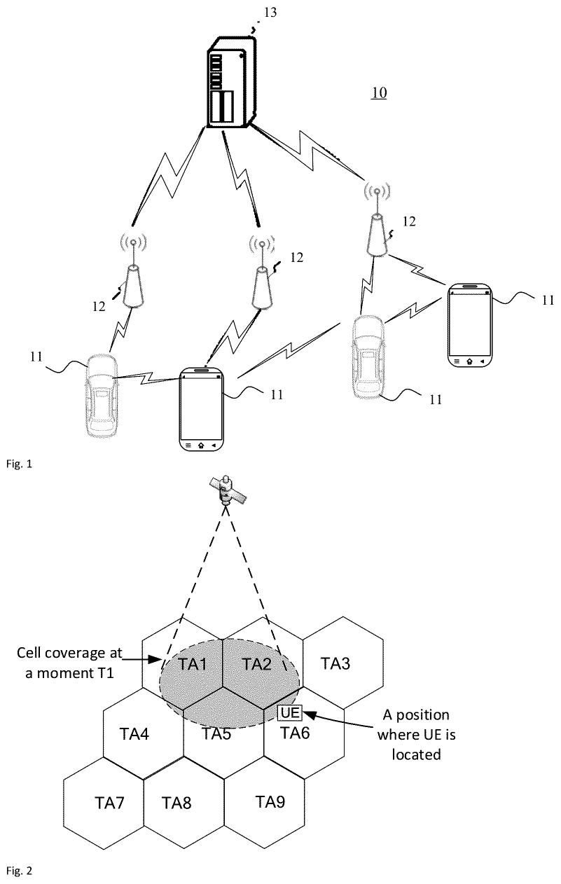

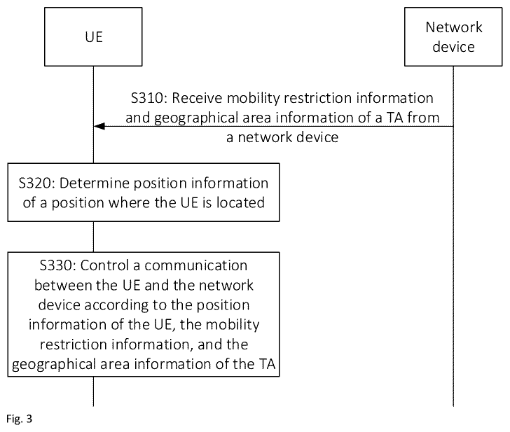

As shown in FIG. 2, at a moment T1, the satellite cell broadcasts TAIs of a TA1, a TA2 and a TA5 to the UE, but the UE is currently actually located in a TA6.

Since the TAI representing an actual position of the UE is not included in the broadcast TAIs, according to related technology, the communication between the UE and the network device is restricted in a case that the broadcast TAIs belong to TAIs in the non-allowable area of the SAR. However, since the current actual TAI of the UE does not belong to the non-allowable area of the SAR, the communication between the UE and the network device actually needs to be allowed. That is to say, this results in that the UE originally needing to be allowed to communicate is forbidden from establishing a network connection.

Alternatively, not all the broadcast TAIs belong to the non-allowable area of the SAR, the UE is allowed to establish a connection and communicate with the network, but the actual TAI of the UE belongs to the non-allowable area of the SAR, the communication between the UE and the network device actually needs to be restricted. This results in that the UE originally needing to be restricted from communicating with the network device accesses to the network and communicates with the network device.

In the above-mentioned cases, erroneous judgment occurs to control over the UE accessing to the network. However, assuming that the AMF performs the SAR control or the FA control according to the TA where the UE is located currently, as the UE cannot sense change of the TA where the UE is located, the UE cannot sense when to initiate the communication with the network again in a case that the UE is located in the non-allowable area of the SAR or FA and is restricted from communicating with the network.

In view of this, as shown in FIG. 3, an example of the disclosure provides a UE communication control method, performed by user equipment (UE) and including steps S310, S320 and S330.

Step S310 includes receiving mobility restriction information and geographical area information of a tracking area (TA) from a network device.

Step S320 includes determining position information of a position where the UE is located.

Step S330 includes controlling a communication between the UE and the network device according to the position information of the UE, the mobility restriction information, and the geographical area information of the TA.

The UE may be various terminals capable of communicating, for example, a communication device capable of residing on non terrestrial networks (NTN).

The network device includes but is not limited to an access management function (AMF).

The mobility restriction information may be information used for at least one of mobility restriction or service access restriction for the UE. The mobility restriction information may be generated by the network device and issued to the UE. For example, the AMF may dynamically generate the mobility restriction information according to subscription information of the UE, the position where the UE is located currently and policy information obtained by the AMF. For example, the TA for the position where the UE is located currently, at least one of a wireless coverage condition or a load condition of these TAs, and the like may be used for generating the mobility restriction information by the AMF.

In an example, the mobility restriction information and the geographical area information may be jointly used for performing at least one of mobility restriction or service access restriction on the UE.

In some examples, the geographical area information indicates a geographical area of the TA. For example, the geographical area information may include but is not limited to at least one of:
position information of a central point of the TA and an inner diameter or a radius of the geographical area; or
position information of a plurality of boundary points of the TA.

The position information includes but is not limited to at least one of longitude and latitude, or relative position information relative to a reference point. The reference point may be any pre-determined reference position.

In some examples, the TA involved in the geographical area information may be a TA indicated by the mobility restriction information, namely, the geographical area information of the TA includes geographical area information of a TA indicated by the mobility restriction information.

For example, the mobility restriction information includes a TAI of a TA1, a TAI of a TA2 and a TAI of a TA3; and the geographical area information of the TA may include geographical area information of the TA1, geographical area information of the TA2 and geographical area information of the TA3.

In a case that the geographical area information of the TA is geographical position information of a TA indicated by the mobility restriction information, the mobility restriction information and the geographical area information of the TA received together by the UE from the network device may include the TAI and description information of a geographical area corresponding to the TAI. In this way, bit overheads occupied by TA information such as the TAI for identifying the TA in interaction messages between the UE and the network device may be reduced.

In some examples, the mobility restriction information and the geographical area information of the TA may be transmitted separately. In this way, the UE may receive the mobility restriction information and the geographical area information of the TA through different messages.

In some examples, Step S320 may include:
obtaining the position information of the UE by positioning the UE based on a positioning system, for example, the position information of the UE may be obtained by positioning the UE based on a global positioning system (GPS), or the position information of the UE may be obtained by positioning the UE based on a Beidou System; or
obtaining the position information of the UE by positioning the UE based on triangulation and other manners, for example, at least one of the UE or a base station transmits a positioning signal, then a relative position between the UE and the base station may be obtained, and the position information of the position where the UE is located may be obtained based on the relative position and a position of the base station.

For example, the UE may determine its own position information periodically, or the UE may determine its own position information upon detecting a trigger event. For example, upon detecting that its own displacement amount reaches a preset amount based on its own inertial sensor, the UE may determine that the trigger event is detected. Alternatively, upon discovering that a signal quality fluctuating value of a wireless signal reaches a preset value while performing wireless signal measurement, the UE may also determine that the trigger event is detected.

In some examples, Step S330 may include determining whether the UE in a current position may communicate with the network device and/or which of aspects the UE in the current position may communicate with the network device, after the UE obtains its own position information and receives the mobility restriction information and the geographical area information of the TA from the network device.

In this way, by the transmission of the geographical area information of the TA, the UE may precisely control the communication between the UE and the network device according to the position information of the UE, the geographical area information of the TA and the mobility restriction information rather than preliminarily believe that a TA where the UE is located currently is in TAs indicated by identifications broadcast by the network device according to the identifications of the TAs broadcast by the network device and the mobility restriction information received at a current moment, so that precision of control over the communication between the UE and the network device is improved.

The network device that broadcasts the identifications of the TAs may be a base station.

Controlling the communication between the UE and the network device in Step S330 may include at least one of:
forbidding any communication between the UE and at least one of an access network device or a core network device;
allowing all communications between the UE and at least one of the access network device or the core network device; or
allowing partial communications between the UE and at least one of the access network device or the core network device. The partial communications may include partial communications such as the UE being capable of residing in the network, registration management and paging. The partial communications do not include a service communication between the UE and the network device.

The access network device in the disclosure may at least include a base station. The base station may be at least one of eNB or gNB.

The core network device may include at least one of an AMF, a user plane function (UPF) or a session management function (SMF).

In an example, the mobility restriction information includes at least one of service area restriction (SAR) information or forbidden area (FA) information. The SAR information is configured to indicate an allowable area or a non-allowable area. The allowable area is an area that is allowed to provide a service for the UE and may be represented by a TA. The UE is allowed to perform a normal service communication with the network in the allowable area. The non-allowable area is an area that is restricted from providing a service for the UE and may be represented by a TA. In the non-allowable area, the UE may be allowed to reside in the network but cannot perform the service communication with the network. The FA information is configured to indicate a forbidden area. The forbidden area is a TA that is forbidden from providing a service for the UE.

The SAR information may include a TAI of one TA or TAIs of a plurality of TAs. The SAR information may include a TAI of a TA that allows the network device to provide a service for the UE. Alternatively the SAR information may include a TAI of a TA that restricts the network device from providing a service for the UE.

The FA information may include a TAI of one TA or TAIs of a plurality of TAs. The TA indicated by the TAI in the FA information constitutes the forbidden area. In these TAs, the UE is forbidden from communicating with the network device.

Both the SAR information and the FA information may be formed in a list form. For example, at least one of the SAR information or the FA information may include a TAI list.

In an example, the mobility restriction information is the SAR information, and the geographical area information of the TA may be geographical area information of a TA that is allowed to provide a service for the UE, or geographical area information of a TA that is restricted from providing a service for the UE.

In another example, the mobility restriction information is the FA information, and the geographical area information of the TA may be geographical area information of a TA forbidding the UE from accessing as indicated by the FA information.

In some other examples, the geographical area information of the TA may include geographical area information of all TAs related to the UE. All the TAs related to the UE may include at least one of a TA that is allowed to provide a service for the UE, a TA that is restricted from providing a service for the UE, a TA that forbids the UE from accessing or a TA in a registration area (RA) of the UE. It is to be noted that, the description here is merely an example, and specific embodiments are not limited to this example.

Step S330 may include at least one of:
allowing the UE to communicate with the network device in a case that the UE is located in a geographical area of a TA indicated by the SAR information as being allowed to provide a service for the UE;
forbidding a service communication between the UE and the network device in a case that the UE is located outside a geographical area of a TA indicated by the SAR information as being allowed to provide a service for the UE;
forbidding the service communication between the UE and the network device in a case that the UE is located in a geographical area of a TA indicated by the SAR information as being restricted from providing a service for the UE;
allowing the UE to communicate with the network device in a case that the UE is located outside a geographical area of a TA indicated by the SAR information as being restricted from providing a service for the UE;
forbidding any communication between the UE and the network device in a case that the UE is located in a geographical area of a TA indicated by the FA information as forbidding the UE from communicating; or
allowing all communications between the UE and the network device in a case that the UE is located outside a geographical area of a TA indicated by the FA information as forbidding the UE from communicating.

In the examples of the disclosure, the UE controls the communication between the UE and the network device according to the position information of the position where the UE is located in combination with the geographical area information of the TA and at least one of the FA information or the SAR information instead of controlling the communication between the UE and the network device based on the received TAIs broadcast by the base station as well as the FA information and the SAR information.

It is to be noted that in a case that a first judgment result conflicts with a second judgment result, the first judgment result may be performed preferably since an priority of the FA control is higher than an priority of the SAR control, where the first judgment result is obtained based on the FA information, the position information of the UE and the geographical area information of a TA indicated by the FA information and is used for controlling a communication condition between the UE and the network device, and the second judgment result is obtained based on the SAR information, the position information of the UE and the geographical area information of a TA indicated by the SAR information and is used for controlling a communication condition between the UE and the network device.

In some examples, both the mobility restriction information and the geographical area information of the TA may be carried in a non-access stratum (NAS) message from the network device. This NAS message may be a response message for an NAS message transmitted by the UE.

In some examples, Step S310 may include at least one of:
receiving a registration response message including the mobility restriction information and the geographical area information of the TA;
receiving a service response message including the mobility restriction information and the geographical area information of the TA; or
receiving a configuration update message including the mobility restriction information and the geographical area information of the TA.

The NAS message is received by the base station from a network device of a core network and then transparently transmitted to the UE by the base station.

In an example, the UE communication control method further includes: transmitting a registration request message, where the registration response message is returned based on the registration request message; or transmitting a service request message, where the service response message is returned based on the service request message.

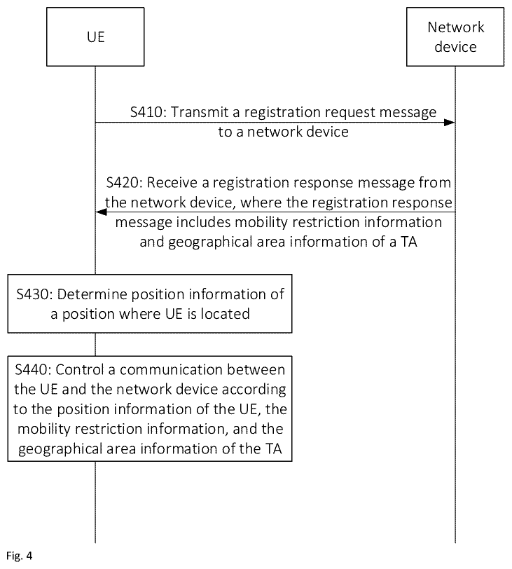

As shown in FIG. 4, an example of the disclosure provides a UE communication control method, performed by the UE and including Steps S410, S420, S430 and S440.

Step S410 includes transmitting a registration request message to the network device.

Step S420 includes receiving a registration response message from the network device, where the registration response message include: the mobility restriction information and the geographical area information of the TA.

Step S430 includes determining position information of a position where the UE is located.

Step S440 includes controlling a communication between the UE and the network device according to the position information of the UE, the mobility restriction information, and the geographical area information of the TA.

In this way, during an initial registration or registration update process, the UE may obtain the mobility restriction information and the geographical area information of the TA from information interaction with the network device of the core network.

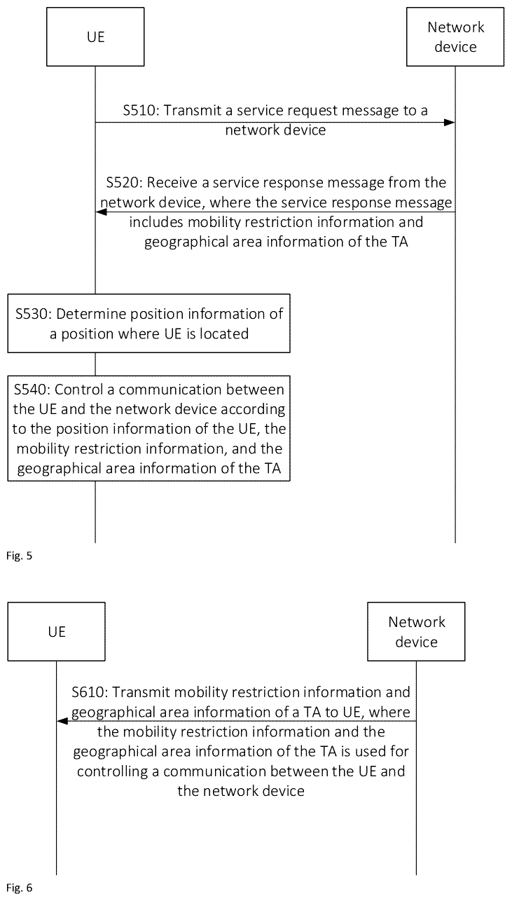

As shown in FIG. 5, an example of the disclosure provides a UE communication control method, performed by the UE and including steps S510, S520, S530 and S540.

Step S510 includes transmitting a service request message to the network device.

Step S520 includes receiving a service response message from the network device, where the service response message includes the mobility restriction information and the geographical area information of the TA.

Step S530 includes determining position information of a position where the UE is located.

Step S540 includes controlling a communication between the UE and the network device according to the position information of the UE, the mobility restriction information, and the geographical area information of the TA.

In this way, in a process that the UE requests for a communication service from the network device of the core network, the UE may obtain the mobility restriction information and the geographical area information of the TA from the information interaction with the network device of the core network.

In some examples, the UE communication control method further includes: updating mobility restriction information and geographical area information of the TA stored by the UE according to the received mobility restriction information and the received geographical area information of the TA.

After the UE receives the mobility restriction information and the geographical area information of the TA, the network device will retransmit mobility restriction information and geographical area information of the TA to the UE in a case that the network device detects that there is a demand for updating at least one of the mobility restriction information or the geographical area information of the TA. In this way, the UE will receive updated mobility restriction information and/or updated geographical area information of the TA, and update the mobility restriction information and/or the geographical area information of the TA stored locally by the UE according to the received updated mobility restriction information and/or the received updated geographical area information of the TA.

In an example, the UE communication control method further includes deleting the stored mobility restriction information and the stored geographical area information of the TA in a case that the UE is shut down or deregistered.

The stored mobility restriction information and the stored geographical area information of the TA are deleted every time the UE is shut down or deregistered from the network. In this way, after the UE is started or upon the UE is re-registered to the network after detecting a network registration, at least one of the mobility restriction information or the geographical area information of the TA may be obtained again through a network registration process triggered by the registration request message.

As shown in FIG. 6, an example of the disclosure provides a UE communication control method, performed by a network device and including step S610.

Step S610 includes transmitting mobility restriction information and geographical area information of a tracking area (TA) to user equipment (UE), where the mobility restriction information and the geographical area information of the TA is used for controlling a communication between the UE and the network device.

The network device may include but is not limited to an access management function (AMF). The network device not only transmits the mobility restriction information to the UE, but also transmits the geographical area information of the TA to the UE, so that the UE conveniently controls the communication between the UE and the network device in combination with the position where the UE is located, the geographical area information of the TA and the mobility restriction information.

In an example, the mobility restriction information and the geographical area information may be jointly used for performing at least one of mobility restriction or service access restriction on the UE.

In some examples, the geographical area information indicates a geographical area of the TA. For example, the geographical area information may include but is not limited to at least one of:
position information of a central point of the TA and an inner diameter or a radius of the geographical area; or
position information of a plurality of boundary points of the TA.

The position information includes but is not limited to longitude and latitude.

In some examples, the TA may be a TA indicated by the mobility restriction information, namely, the geographical area information includes geographical area information of a TA indicated by the mobility restriction information.

For example, the mobility restriction information includes a TAI of a TA1, a TAI of a TA2 and a TAI of a TA3; and the geographical area information of the TA may include geographical area information of the TA1, geographical area information of the TA2 and geographical area information of the TA3.

In a case that the geographical area information of the TA is geographical position information of a TA indicated by the mobility restriction information, the mobility restriction information and the geographical area information of the TA received together by the UE from the network device may include the TAI and description information of a geographical area corresponding to the TAI. In this way, bit overheads occupied by TA information such as the TAI for identifying the TA in interaction messages between the UE and the network device may be reduced.

In some examples, the mobility restriction information and the geographical area information of the TA may be transmitted separately. In this way the UE may receive the mobility restriction information and the geographical area information of the TA through different messages.

In an example, the mobility restriction information includes at least one of service area restriction (SAR) information or forbidden area (FA) information. The SAR information is configured to indicate an allowable area or a non-allowable area. The allowable area is an area that is allowed to provide a service for the UE and may be represented by a TA. The UE is allowed to perform a normal service communication with the network in the allowable area. The non-allowable area is an area that is restricted from providing a service for the UE and may be represented by a TA. In the non-allowable area, the UE may be allowed to reside in the network but cannot perform the service communication with the network. The FA information is configured to indicate a forbidden area. The forbidden area is a TA that is forbidden from providing a service for the UE.

The SAR information may include a TAI of one TA or TAIs of a plurality of TAs. The SAR information may include a TAI of a TA that allows the network device to provide a service for the UE. Alternatively the SAR information may include a TAI of a TA that restricts the network device from providing a service for the UE.

The FA information may include a TAI of one TA or TAIs of a plurality of TAs. The TA indicated by the TAI in the FA information is a TA that forbids the UE from communicating with the network device.

Both the SAR information and the FA information may be provided in a list form. For example, at least one of the SAR information or the FA information may include a TAI list.

In an example, the mobility restriction information is the SAR information, and the geographical area information of the TA may be geographical area information of a TA that is allowed to provide a service for the UE, or geographical area information of a TA that is restricted from providing a service for the UE.

In another example, the mobility restriction information is the FA information, and the geographical area information of the TA may be geographical area information of a TA indicated by the FA information as forbidding the UE from accessing.

In some other examples, the geographical area information of the TA may include geographical area information of all TAs related to the UE. All the TAs related to the UE may include at least one of a TA that is allowed to provide a service for the UE, a TA that is restricted from providing a service for the UE, a TA that forbids the UE from accessing or a TA in a registration area (RA) of the UE. It is to be noted that, the description here is merely an example, and specific embodiments are not limited to this example.

In a case that the network device is a core network device, the network device may transmit the mobility restriction information and the geographical area information of the TA to the UE through various non-access stratum (NAS) messages. For example, the UE communication control method further includes receiving a registration request message; and transmitting the mobility restriction information and the geographical area information of the TA to the UE includes transmitting a registration response message including the mobility restriction information based on the registration request message.

The mobility restriction information and the geographical area information of the TA are included in the registration response message to be transmitted to the UE without introducing a new message to transmit the geographical area information of the TA and the mobility restriction information, and thus a characteristic of being easy and convenient to implement is achieved.

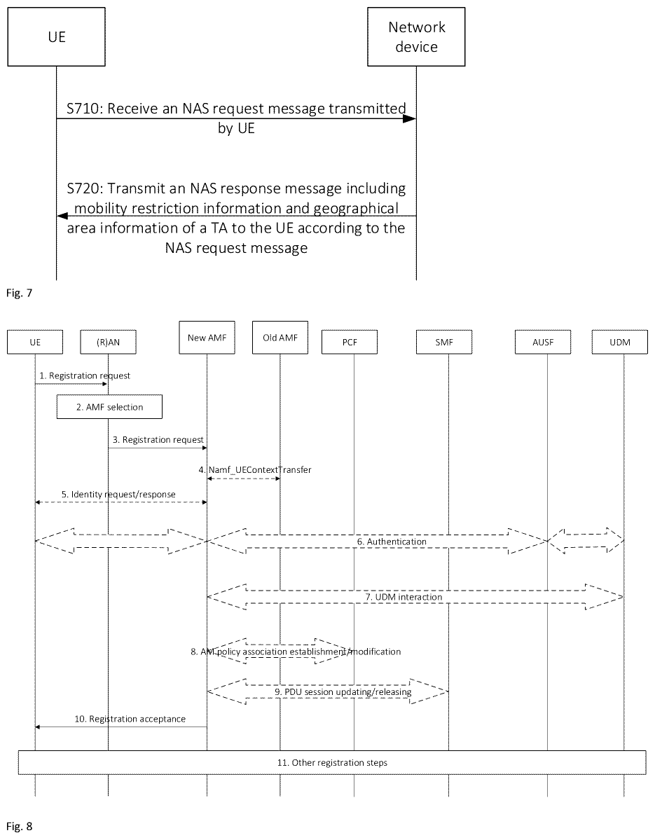

As shown in FIG. 7, an example of the disclosure provides a UE communication control method, performed by the network device and including steps S710 and S720.

Step S710 includes receiving a non-access stratum (NAS) request message transmitted by the UE.

Step S720 includes transmitting an NAS response message including the mobility restriction information and the geographical area information of the TA to the UE according to the NAS request message.

In some examples, the NAS request message includes but is not limited to at least one of an NAS registration request message, a service request message or a configuration request message.

Correspondingly, the NAS response message includes but is not limited to at least one of an NAS registration response message, a service response message or a configuration update message.

The mobility restriction information and the geographical area information of the TA mentioned in this example may refer to related description of any example described above and/or below, which is not repeated here.

In some other examples, the UE communication control method further includes receiving a service request message; and transmitting the mobility restriction information to the UE includes transmitting a service response message including the mobility restriction information based on the service request message.

The mobility restriction information and the geographical area information of the TA are included in the service response message to be transmitted to the UE without introducing a new message to transmit the geographical area information of the TA and the mobility restriction information, and thus a characteristic of being easy and convenient to implement is achieved.

In some examples, transmitting the mobility restriction information and the geographical area information of the TA to the UE includes transmitting a configuration update message including updated mobility restriction information and updated geographical area information of the TA to the UE in a case that configuration change for the UE involves updating of the mobility restriction information.

In this way, the updated mobility restriction information and/or geographical area information of a TA indicated after updating the mobility restriction information are directly transmitted to the UE in the configuration update message without introducing a new message, and a characteristic of being easy and convenient to implement is achieved.

The mobility restriction information is directly transmitted to the UE by using the configuration update message in a case that the configuration change for the UE involves updating of the mobility restriction information.

The configuration update message may be actively pushed by the network device or requested for by the UE.

In some examples, the UE communication control method further includes transmitting the updated mobility restriction information to user data management (UDM).

As the mobility restriction information for the UE is updated, the network device needs to store the updated mobility restriction information to the UDM, and subsequently, the network device or another network device searches out the updated mobility restriction information from the UDM.

In some examples, the geographical area information includes geographical area information of a TA indicated by the mobility restriction information.

An example of the disclosure provides a method for performing SAR control on the UE, a corresponding embodiment of which may also be applied to FA control.

The network device transmits a TAI list for SAR and geographical area information corresponding to a TA identified by each TAI to the UE. The TAI list for SAR may be one type of SAR information. In some examples, the network device may also transmit FA information and geographical area information of the TA to the UE. The FA information may include a TAI list, and the TAI list indicates a TA that forbids the UE from accessing.

The geographical area information may be various geographical area information capable of being recognized by the UE. For example, the geographical area information may include longitude and latitude. The geographical area information may be carried by a geographical area description (GAD) information unit.

The TAI list for SAR may be a TAI list for a non-allowable area, or a TAI list for an allowable area. The TAI list for the allowable area includes one TAI or a plurality of TAIs, and in a case that the UE is located in geographical areas of TAs indicated by these TAIs, the UE is allowed to communicate with the network device and the network device may provide various services for the UE. The TAI list for the non-allowable area may include one TAI or a plurality of TAIs, and in a case that the UE is located in geographical areas of these TAs, the UE may reside in the network to perform communication interaction related to registration management and session management but cannot perform service communication with the network, for example, data services such as video and game. The TAI list for SAR and corresponding geographical area information may be transmitted to the UE through the registration response message, the service request response message, a configuration management message and other messages.

The UE compares current position information with geographical area information corresponding to the TAI for SAR. In a case that a current position of the UE is located in the non-allowable area of SAR, the UE does not initiate the service communication with the network. In a case that the current position of the UE is located outside the non-allowable area of SAR, the UE may perform any communication with the network.

In a case that the UE receives the TAI list for SAR and the belonging corresponding geographical area information from the network, information originally stored on the UE will be covered.

The SAR information and the geographical area information of the TA will be deleted from the UE in a case that the UE is shut down or deregistered from the network.

The above-mentioned solutions may be applied to a plurality of processes such as access registration and service request, which are described in detail in the following examples.

In a case that the UE initiates initial registration, a registration successful message returned by the AMF includes the SAR information and the geographical area information of the TA indicated by the SAR information, a process of which is shown in FIG. 8 and includes the following.
1. The UE transmits a registration request. The registration request includes access network parameters, a registration type, subscription concealed identifier (SUCI) or 5G-globally unique temporary UE identity (GUTI), a permanent equipment identifier (PEI) and requested network slice selection assistance information (NSSAI), and in a case that a last visited TAI is available, the registration request further includes a TAI of the last visited TA. The registration type indicates whether the UE intends to perform initial registration, mobility registration updating, periodical registration updating or emergency updating. The TAI of the last visited TA is included in the registration request and may be used for determining an RA of the UE by the AMF.
2. The AMF is selected. For example, the AMF is selected after an access network/radio access network ((R)AN) receives the registration request message.
3. The registration request is transmitted to the selected AMF. For example, the (R)AN transmits an N2 message to a new AMF, and the N2 message includes an N2 parameter, aforementioned registration request, and the like. The N2 parameter includes information related to a cell where the UE resides currently, such as a selected public land mobile network ID, position information of the UE and a cell identification.
4. Namf-UEContextTransfer between the new AMF and an old AMF is performed. The new AMF here is the AMF selected in the previous step, and the old AMF is an AMF for providing mobility access management and control for the UE before the new AMF. For example, in a case that the AMF for the UE changes, the new AMF needs to obtain a subscription permanent identifier (SUPI) of the UE and a UE context from the old AMF.
5. Identity request and identity response between the new AMF and the UE are transmitted.
6. UE authentication is performed. For example, the new AMF and an authentication server function (AUSF) interact for information of UE authentication.
7. Information interaction between the new AMF and an UDM is performed. For example, after the AMF for the UE changes, the new AMF may select and be registered to the UDM and obtain subscription data of the UE from the UDM in a case that the new AMF does not obtain an effective UE context. For example, the subscription data includes but is not limited to access and mobility subscription data and the like.
8. The new AMF and a policy control function (PCF) perform access management (AM) policy association establishment/updating.
9. Protocol data unit (PDU) session updating/releasing is performed. For example, the AMF transmits Nsmf-PDU-UpdateSMContext Request to a session management function (SMF) to activate a user plane connection of a PDU session.
10. The new AMF transmits a registration accept response to the UE to indicate that the registration request of the UE is accepted. The registration accept response may carry the mobility restriction information and the geographical area information of the TA. It is to be noted that, the registration accept response may further include an RA, a mobility restriction condition, NSSAI of a network slice that is allowed to access to, periodical registration timer indication and the like.
11. The rest of steps of the registration process is performed.

The UE stores the information. Afterwards, in a case that the UE moves, the UE judges whether its current position is located in the non-allowable area of the SAR. In a case that the current position of the UE is located in the non-allowable area of the SAR, the UE no longer initiates a service communication with the network; otherwise, the UE may perform any communication with the network.

In a case that the UE initially accesses to the network, gNB transmits the broadcast TAIs to the AMF, and the AMF judges whether all the TAs indicated by the broadcast TAIs are located in TAs corresponding to the non-allowable area indicated by the SAR information. In a case that all the TAs indicated by the broadcast TAIs are located in the TAs corresponding to the non-allowable area indicated by the SAR information, the AMF returns a registration reject message, and the registration reject message includes the SAR and corresponding geographical area information. For example, in a case that the gNB does not obtain the position information of the current position of the UE or does not provide the position information of the UE for the AMF, the broadcast TAIs may be directly reported to the AMF.

As shown in FIG. 9, the UE communication control method according to the examples of the disclosure may include the following steps.
1. The UE transmits a registration request. The registration request includes access network parameters, a registration type, a subscription concealed identifier (SUCI) or 5G-globally unique temporary UE identity (GUTI), a permanent equipment identifier (PEI) and requested network slice selection assistance information (NSSAI), and in a case that a last visited TAI is available, the registration request further includes a TAI of the last visited TA. The registration type indicates whether the UE intends to perform initial registration, mobility registration updating, periodical registration updating or emergency updating. The TAI of the last visited TA is included in the registration request and may be used for determining an RA of the UE by the AMF.
2. The AMF is selected. For example, the AMF is selected after an access network/radio access network ((R)AN) receives the registration request message.
3. The registration request is transmitted to the selected AMF. For example, the (R)AN transmits an N2 message to a new AMF, and the N2 message includes an N2 parameter, aforementioned registration request, and the like. The N2 parameter includes information related to a cell where the UE resides currently, such as a selected public land mobile network ID, position information of the UE and a cell identification.
4. Namf-UEContextTransfer between the new AMF and an old AMF is performed. The new AMF here is the AMF selected in the previous step, and the old AMF is an AMF for providing mobility access management and control for the UE before the new AMF. For example, in a case that the AMF for the UE changes, the new AMF needs to obtain a subscription permanent identifier (SUPI) of the UE and a UE context from the old AMF.
5. Identity request and identity response between the new AMF and the UE are transmitted.
6. UE authentication is performed. For example, the new AMF and an authentication server function (AUSF) interact for information of UE authentication.
7. Information interaction between the new AMF and an UDM is performed. For example, after the AMF for the UE changes, the new AMF may select and be registered to the UDM and obtain subscription data of the UE from the UDM in a case that the new AMF does not obtain an effective UE context. For example, the subscription data includes but is not limited to access and mobility subscription data and the like.
8. The new AMF and a policy control function (PCF) perform access management (AM) policy association establishment/updating.
9. Protocol data unit (PDU) session updating/releasing is performed. For example, the AMF transmits Nsmf-PDU-UpdateSMContext Request to a session management function (SMF) to activate a user plane connection of a PDU session.
10. The new AMF transmits a registration accept response to the UE to indicate that the registration request of the UE is accepted. The registration accept response may carry the mobility restriction information and the geographical area information of the TA. It is to be noted that, the registration accept response may further include an RA, mobility restriction information, NSSAI of a network slice that is allowed to access to, periodical registration timer indication and the like.
11. The mobility restriction information and the geographical area information of the TA are stored. The mobility restriction information includes at least one of the SAR information or the FA information.
12. The rest of steps of the registration process is performed.

It is to be noted that, in the abovementioned step 7, the AMF obtains the subscription information of the UE from the UDM, and in a case that a TA list corresponding to the non-allowable area of SAR in the subscription information of the UE includes all the broadcast TAs, the service communication between the UE and the network device needs to be forbidden.

In step 10, the AMF returns the registration reject message to the UE based on step 7, where the registration reject message may include a reject reason. Meanwhile, the registration reject message may further include a TAI list corresponding to the SAR and the geographical area information corresponding to each TA.

In step 11, the UE stores the TAI list for the SAR and corresponding geographical area information according to the received registration reject message.

In a case that the UE moves and the current position of the UE is not located in the non-allowable area of SAR, the UE initiates the service communication again.

After the UE is successfully registered to the network, the UE may initiate a service request to the network. The gNB receives the service request, then obtains the TA where the UE is located currently according to the current position information of the UE and provides the TAI for the AMF. In a case that the AMF judges according to the subscription information that the TA where the UE is located currently is located in the FA though not all the broadcast TAIs are included in the FA information, the AMF is supposed to return a service reject message.

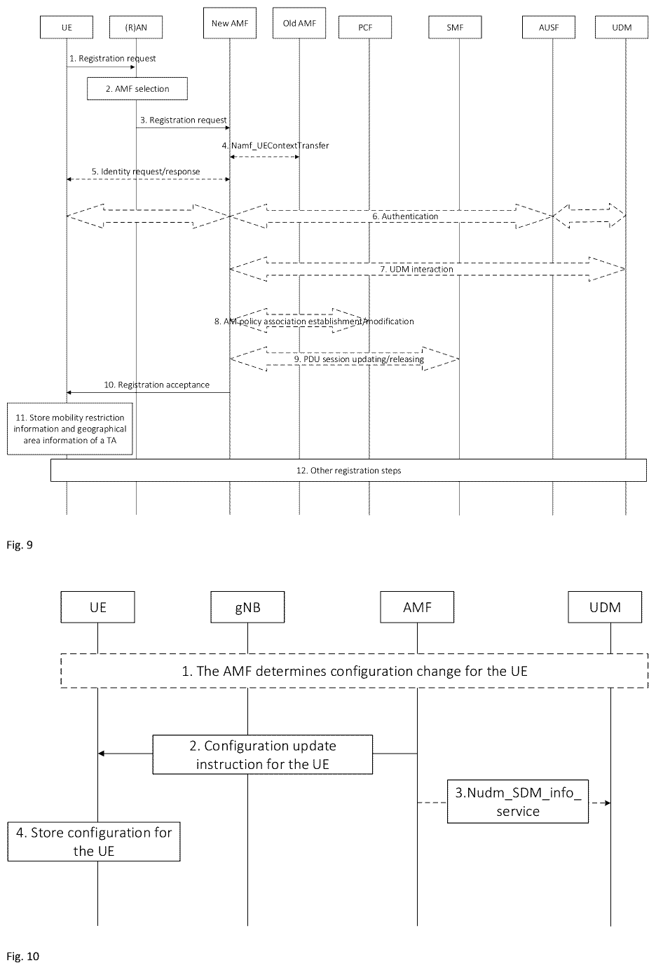

As shown in FIG. 10, the UE communication control method according to the examples may include the following steps.
1. The AMF determines configuration change for the UE. For example, the AMF decides to change the configuration for the UE, for example, at least one of the SAR information or the FA information for the UE needs to be changed.
2. The AMF transmits a configuration update message to the UE. The configuration update message includes the TAI list for the SAR and the geographical area information corresponding to the TA identified by each TAI; and/or, the configuration update message includes the TAI list for FA and the geographical area information corresponding to the TA identified by each TAI.
3. In a case that the subscription information of the UE changes, the AMF further needs to synchronize a latest TAI list for the SAR and geographical area information corresponding to a TA identified by each TAI into the subscription information of the UE on the UDM. For example, the AMF transmits the updated mobility restriction information and the updated geographical area information of the TA to the UDM through Nudm-SDM-info-service.
4. The configuration for the UE is stored. For example, the UE receives the configuration update message and stores the TAI list for the SAR and corresponding geographical area information. In a case that the UE has previously stored information, the UE will overwrite the previously stored information by using the received latest TAI for the SAR and corresponding geographical area information.

Afterwards, in a case that the current position of the UE changes, the UE needs to determine whether the current position of the UE is located in the geographical area corresponding to the non-allowable area of the SAR, and if yes, the UE does not perform a service communication with the network temporarily.

As shown in FIG. 11, an example of the disclosure provides a UE communication control apparatus. The UE communication control apparatus 100 includes a first receiving module 110, a determining module 120 and a control module 130.

The first receiving module 110 is configured to receive mobility restriction information and geographical area information of a tracking area (TA) from a network device.

The determining module 120 is configured to determine position information of a position where user equipment (UE) is located.

The control module 130 is configured to control a communication between the UE and the network device according to the position information of the UE, the mobility restriction information, and the geographical area information of the TA.

The UE communication control apparatus 100 may be included in the UE.

In some examples, the first receiving module 110, the determining module 120 and the control module 130 may be a program module. The program module, after executed by a processor, may implement functions of the above-mentioned any module.

In some other examples, the first receiving module 110, the determining module 120 and the control module 130 may be a software and hardware combined module. The software and hardware combined module may include various programmable arrays. The programmable arrays include but are not limited to at least one of a field programmable array or a complex programmable array.

In yet some other examples, the first receiving module 110, the determining module 120 and the control module 130 may be a pure hardware module. The pure hardware module includes but is not limited to an application-specific integrated circuit.

In some examples, the mobility restriction information includes at least one of service area restriction (SAR) information or forbidden area (FA) information. The SAR information is configured to indicate an allowable area or a non-allowable area. The allowable area is an area that is allowed to provide a service for the UE and may be represented by a TA. The UE is allowed to perform a normal service communication with the network in the allowable area. The non-allowable area is an area that is restricted from providing a service for the UE and may be represented by a TA. In the non-allowable area, the UE may be allowed to reside in the network but cannot perform a service communication with the network. The FA information is configured to indicate a forbidden area. The forbidden area is a TA that is forbidden from providing a service for the UE.

In some examples, the control module 130 is configured to perform at least one of:
allowing any communication between the UE and the network device in a case that the UE is located in a geographical area of a TA indicated by the SAR information as being allowed to provide a service for the UE;
forbidding a service communication between the UE and the network device in a case that the UE is located outside a geographical area of a TA indicated by the SAR information as being allowed to provide a service for the UE;
forbidding the service communication between the UE and the network device in a case that the UE is located in a geographical area of a TA indicated by the SAR information as being restricted from providing a service for the UE;
allowing any communication between the UE and the network device in a case that the UE is located outside a geographical area of a TA indicated by the SAR information as being restricted from providing a service for the UE;
forbidding any communication between the UE and the network device in a case that the UE is located in a geographical area of a TA indicated by the FA information as forbidding the UE from communicating; or
allowing any communication between the UE and the network device in a case that the UE is located outside a geographical area of a TA indicated by the FA information as forbidding the UE from communicating.

In some examples, the first receiving module 110 is configured to receive a registration response message including the mobility restriction information and the geographical area information of the TA; or receive a service response message including the mobility restriction information and the geographical area information of the TA; or receive a configuration update message including the mobility restriction information and the geographical area information of the TA.

In some examples, the UE communication control apparatus 100 further includes a first transmitting module (not shown).

The first transmitting module is configured to transmit a registration request message, where the registration response message is returned based on the registration request message; or transmit a service request message, where the service response message is returned based on the service request message.

In some examples, the UE communication control apparatus 100 further includes an updating module (not shown), configured to update the mobility restriction information and the geographical area information of the TA stored by the UE according to the received mobility restriction information and the received geographical area information of the TA.

In some examples, the UE communication control apparatus 100 further includes a deleting module (not shown), configured to delete the stored mobility restriction information and the stored geographical area information of the TA in a case that the UE is shut down or deregistered.

In some examples, the geographical area information includes geographical area information of a TA indicated by the mobility restriction information.

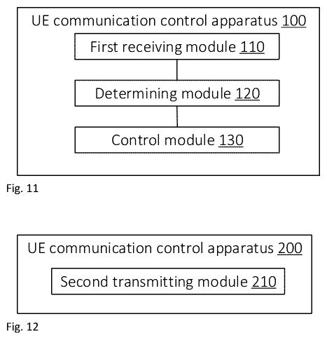

As shown in FIG. 12, an example of the disclosure provides a UE communication control apparatus. The UE communication control apparatus 200 includes a second transmitting module 210.

The second transmitting module 210 is configured to transmit mobility restriction information and geographical area information of a tracking area (TA) to user equipment (UE). The mobility restriction information and the geographical area information of the TA is used for controlling a communication between the UE and a network device.

The UE communication control apparatus 200 may be included in the network device. The network device may include but is not limited to an access management function (AMF).

In some examples, the second transmitting module 210 may be a program module. The program module, after executed by a processor, may implement transmission of the mobility restriction information and the geographical area information of the TA.

In some other examples, the second transmitting module 210 may be a software and hardware combined module. The software and hardware combined module may include various programmable arrays. The programmable arrays include but are not limited to at least one of a field programmable array or a complex programmable array.

In yet some other examples, the second transmitting module 210 may be a pure hardware module. The pure hardware module includes but is not limited to an application-specific integrated circuit.

In some examples, the mobility restriction information includes at least one of service area restriction (SAR) information or forbidden area (FA) information. The SAR information is configured to indicate an allowable area or a non-allowable area. The allowable area is an area that is allowed to provide a service for the UE and may be represented by a TA. The UE is allowed to perform a normal service communication with the network in the allowable area. The non-allowable area is an area that is restricted from providing a service for the UE and may be represented by a TA. In the non-allowable area, the UE may be allowed to reside in the network but cannot perform the service communication with the network. The FA information is configured to indicate a forbidden area. The forbidden area is a TA that is forbidden from providing a service for the UE.

In some examples, the UE communication control apparatus 200 further includes a second receiving module (not shown), configured to receive a registration request message. The second transmitting module 210 is configured to transmit a registration response message including the mobility restriction information based on the registration request message.

In some examples, the UE communication control apparatus 200 further includes a third receiving module (not shown), configured to receive a service request message. The second transmitting module 210 is configured to transmit a service response message including the mobility restriction information based on the service request message.

In some examples, the second transmitting module 210 is configured to transmit a configuration update message including updated mobility restriction information and updated geographical area information of the TA to the UE in a case that configuration change for the UE involves updating of the mobility restriction information.

In some examples, the second transmitting module 210 is further configured to transmit the updated mobility restriction information to user data management (UDM).

In some examples, the geographical area information includes geographical area information of a TA indicated by the mobility restriction information.

An example of the disclosure provides a communication device, including:
a memory configured to store a processor-executable instruction;
a processor, connected with the memory;
where the processor is configured to perform the UE communication control method according to the disclosure.

The processor may include various types of storage media. The storage medium may be a non-transitory computer storage medium and can continue memorizing information stored on the storage medium after the communication device has a power failure.

The communication device includes at least one of UE or a network device. The network device may at least include a core network device. The core network device may include an AMF and the like. The core network device may include a network device of a core network.

The processor may be connected with the memory through a bus and the like and configured to read an executable program stored on the memory, for example, at least one of the UE communication control methods shown in FIG. 3 to FIG. 9.

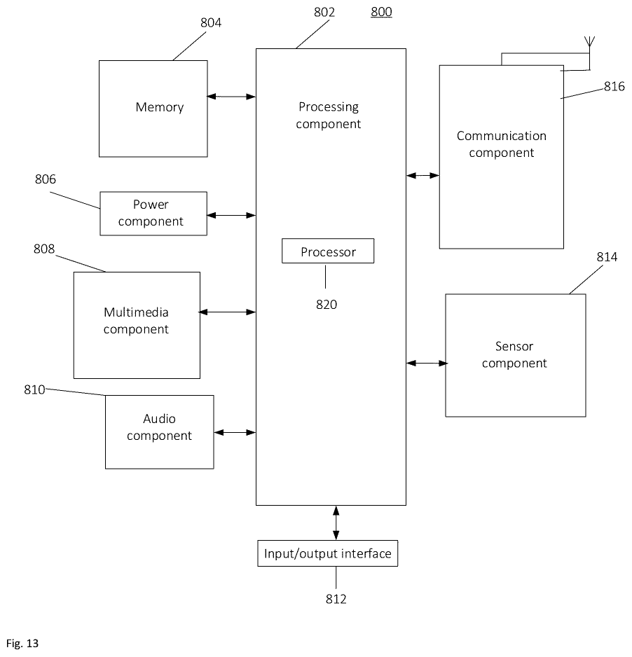

FIG. 13 is a block diagram of UE 800 according to an example. For example, the UE 800 may be a mobile phone, a computer, digital broadcast user equipment, a messaging device, a game console, a tablet device, a medical device, a fitness facility, a personal digital assistant and the like.

Referring to FIG. 13, the UE 800 may include one or more components as follows: a processing component 802, a memory 804, a power component 806, a multimedia component 808, an audio component 810, an input/output (I/O) interface 812, a sensor component 814 and a communication component 816.

The processing component 802 generally controls whole operation of the UE 800, such as operations related to display, phone call, data communication, camera operation and recording operation. The processing component 802 may include one or more processors 820 for executing instructions so as to complete all or part of steps of the above-mentioned methods. Besides, the processing component 802 may include one or more modules to facilitate interaction between the processing component 802 and the other components. For example, the processing component 802 may include a multimedia module so as to facilitate interaction between the multimedia component 808 and the processing component 802.

The memory 804 is configured to store various types of data so as to support operations on the UE 800. Examples of these data include instructions of any application program or method for operation on the UE 800, contact person data, telephone directory data, messages, pictures, videos and the like. The memory 804 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 806 provides power for various components of the UE 800. The power component 806 may include a power management system, one or more power sources, and other components related to power generation, management and distribution for the UE 800.

The multimedia component 808 includes a screen which provides an output interface between the UE 800 and a user. In some examples, the screen may include a liquid crystal display (LCD) and a touch panel (TP). In a case that the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to touching or swiping operation. In some examples, the multimedia component 808 includes at least one of a front camera or a back camera. When the UE 800 is in an operation mode, such as a photographing mode or a video mode, at least one of the front camera or the back camera can receive external multimedia data. Each front camera and each back camera may be a fixed optical lens system or have a focal length and an optical zoom capability.

The audio component 810 is configured to output and/or input an audio signal. For example, the audio component 810 includes a microphone (MIC). When the UE 800 is in the operation mode, such as a call mode, a recording mode and a voice recognition mode, the microphone is configured to receive an external audio signal. The received audio signal may be further stored in the memory 804 or transmitted via the communication component 816. In some examples, the audio component 810 further includes a speaker for outputting the audio signal.

The I/O interface 812 provides an interface between the processing component 802 and a peripheral interface module. The peripheral interface module may be a keyboard, a click wheel, buttons and the like. These buttons may include but are not limited to a home button, a volume button, a start button and a lock button.

The sensor component 814 includes one or more sensors, configured to provide state evaluation of various aspects for the UE 800. For example, the sensor component 814 may detect a on/off state of the UE 800 and relative positioning of the components, for example, the components are a display and a keypad of the UE 800. The sensor component 814 may further detect position change of the UE 800 or one component of the UE 800, whether there is contact between the user and the UE 800, azimuth or speed up/speed down of the UE 800 and temperature change of the UE 800. The sensor component 814 may include a proximity sensor, configured to detect existence of a nearby object without any physical contact. The sensor component 814 may further include an optical sensor, such as a CMOS or CCD image sensor, for use in imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the UE 800 and other devices. The UE 800 may be accessed to a wireless network based on a communication standard, such as WiFi, 2G or 3G, or their combination. In an example, the communication component 816 receives a broadcast signal or related broadcast information from an external broadcast management system via a broadcast channel. In an example, the communication component 816 further includes a near-field communication (NFC) module so as to facilitate short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the UE 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements for performing the methods according to the disclosure.

In an example, a non-transitory computer-readable storage medium including instructions is further provided, such as a memory 804 including the instructions. The instructions may be executed by the processor 820 of the UE 800 so as to complete the methods according to the disclosure. For example, the non-transitory computer-readable storage medium may be an ROM, a random access memory (RAM), a CD-ROM, a magnetic tape, a floppy disk, an optical data storage device and the like. The non-transitory computer-readable storage medium stores an executable instruction which may implement, after executed by the processor, the UE communication control methods shown in any one of FIG. 3 to FIG. 9.

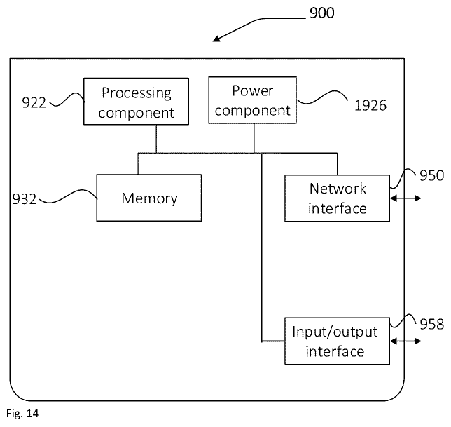

As shown in FIG. 14, an example of the disclosure shows a structure of a communication device. For example, the communication device 900 may be provided as a network device. The communication device 900 may be the above-mentioned network device.

Referring to FIG. 14, the communication device 900 includes a processing component 922 which further includes one or more processors and a memory resource represented by a memory 932, configured to store an instruction capable of being executed by the processing component 922, for example, an application program. The application program stored in the memory 932 may include one or more modules each of which corresponds to a set of instructions. Besides, the processing component 922 is configured to execute the instructions so as to execute any method applied to the communication device as described above, for example, the UE communication control methods shown in FIG. 3 to FIG. 9.

The communication device 900 may further include a power component 1926 configured to execute power management of the communication device 900, a wired or wireless network interface 950 configured to connect the communication device 900 to a network, and an input/output (I/O) interface 958. The communication device 900 may operate an operating system stored in the memory 932, for example, Windows Server™, Mac OS X™, Unix™, Linux™, FreeBSD™or the like.

By means of the technical solutions provided by the examples of the disclosure, the UE may receive the mobility restriction information and the geographical area information of the TA from the network device, and precisely control the communication between the UE and the network device according to the position information of the position where the UE is located, the geographical area information of the TA and the mobility restriction information, thereby reducing a problem of insufficient precision of the UE controlling the communication between the UE and the network device according to TA information received by the UE from an access network in combination with the mobility restriction information.

Those skilled in the art will easily figure out other embodiments of the disclosure after considering the specification and practicing the disclosure. The disclosure intends to cover any variation, use or adaptive change of the disclosure, and these variations, uses or adaptive changes conform to a general principle of the disclosure and include common general knowledge or conventional technical means in the technical field not disclosed by the disclosure. The specification and the examples are merely regarded as examples, and the true scope and spirit of the disclosure are indicated by the following claims.

It is to be understood that the disclosure is not limited to an accurate structure described above and shown in the accompanying drawings, and various modifications and changes can be made without departing from its scope. The scope of the disclosure is limited merely by the appended claims.

1. A user equipment (UE) communication control method, performed by UE and comprising:
receiving mobility restriction information and geographical area information of a tracking area (TA) from a network device;
determining position information of a position where the UE is located; and
controlling a communication between the UE and the network device according to the position information of the UE, the mobility restriction information, and the geographical area information of the TA.

2. The UE communication control method according to claim 1, wherein the mobility restriction information comprises at least one of:
service area restriction (SAR) information that indicates an allowable area or a non-allowable area, the allowable area being a TA that provides a service for the UE, and the non-allowable area being a TA that is restricted from providing a service for the UE; or
forbidden area (FA) information that indicates a forbidden area, the forbidden area being a TA that is forbidden from providing a service for the UE.

3. The UE communication control method according to claim 1, wherein controlling the communication between the UE and the network device according to the position information of the UE, the mobility restriction information, and the geographical area information of the TA comprises at least one of:
allowing communication between the UE and the network device in a case that the UE is located in a geographical area of a TA indicated by SAR information in the mobility restriction information as being allowed to provide a service for the UE;
forbidding service communication between the UE and the network device in a case that the UE is located outside a geographical area of a TA indicated by the SAR information in the mobility restriction information as being allowed to provide a service for the UE;
forbidding the service communication between the UE and the network device in a case that the UE is located in a geographical area of a TA indicated by the SAR information in the mobility restriction information as being restricted from providing a service for the UE;
allowing communication between the UE and the network device in a case that the UE is located outside a geographical area of a TA indicated by the SAR information in the mobility restriction information as being restricted from providing a service for the UE;
forbidding communication between the UE and the network device in a case that the UE is located in a geographical area of a TA indicated by FA information in the mobility restriction information as forbidding the UE from communicating; or
allowing communication between the UE and the network device in a case that the UE is located outside a geographical area of a TA indicated by the FA information in the mobility restriction information as forbidding the UE from communicating.

4. The UE communication control method according to claim 1, wherein receiving the mobility restriction information and the geographical area information of the TA from the network device comprises one of:
receiving a registration response message comprising the mobility restriction information and the geographical area information of the TA;
receiving a service response message comprising the mobility restriction information and the geographical area information of the TA; or
receiving a configuration update message comprising the mobility restriction information and the geographical area information of the TA.

5. The UE communication control method according to claim 4, further comprising:
transmitting a registration request message, wherein the registration response message is returned based on the registration request message; or transmitting a service request message, wherein the service response message is returned based on the service request message.

6. The UE communication control method according to claim 1, further comprising:
updating mobility restriction information and geographical area information of the TA stored by the UE according to the received mobility restriction information and the received geographical area information of the TA.

7. The UE communication control method according to claim 1, further comprising:
deleting the stored mobility restriction information and the stored geographical area information of the TA in a case that the UE is shut down or deregistered.

8. The UE communication control method according to claim 1, wherein the geographical area information comprises geographical area information of a TA indicated by the mobility restriction information.

9. A user equipment (UE) communication control method, performed by a network device and comprising:
transmitting mobility restriction information and geographical area information of a tracking area (TA) to UE, wherein the mobility restriction information and the geographical area information of the TA is used for controlling a communication between the UE and the network device.

10. The UE communication control method according to claim 9, wherein the mobility restriction information comprises at least one of:
service area restriction (SAR) information that indicates an allowable area or a non-allowable area, the allowable area being a TA that provides a service for the UE, and the non-allowable area being a TA that is restricted from providing a service for the UE; or forbidden area (FA) information that indicates a forbidden area, the forbidden area being a TA that is forbidden from providing a service for the UE.

11. The UE communication control method according to claim 9, further comprising receiving a registration request message;
wherein transmitting the mobility restriction information and the geographical area information of the TA comprised in the mobility restriction information to the UE comprises: transmitting a registration response message comprising the mobility restriction information based on the registration request message.

12. The UE communication control method according to claim 9, further comprising receiving a service request message;
wherein transmitting the mobility restriction information to the UE comprises: transmitting a service response message comprising the mobility restriction information based on the service request message.

13. The UE communication control method according to claim 9, wherein transmitting the mobility restriction information and the geographical area information of the TA to the UE comprises:
transmitting a configuration update message comprising updated mobility restriction information and updated geographical area information of the TA to the UE in a case that configuration change for the UE involves updating of the mobility restriction information.

14. The UE communication control method according to claim 13, further comprising:
transmitting the updated mobility restriction information to user data management (UDM).

15. The UE communication control method according to claim 9, wherein the geographical area information comprises geographical area information of a TA indicated by the mobility restriction information.

16-30. (canceled)

31. A communication device, comprising a processor, a transceiver, a memory and an executable program stored on the memory and capable of being run by the processor, wherein the processor, when running the executable program, performs the following:
receiving mobility restriction information and geographical area information of a tracking area (TA) from a network device;
determining position information of a position where user equipment (UE) is located; and
controlling a communication between the UE and the network device according to the position information of the UE, the mobility restriction information, and the geographical area information of the TA.

32. A non-transitory computer storage medium storing an executable program, wherein the executable program, when executed by a processor, causes the processor to implement the UE communication control method according to claim 1.

33. A communication device, comprising a processor, a transceiver, a memory and an executable program stored on the memory and capable of being run by the processor, wherein the processor, when running the executable program, performs the UE communication control method according to claim 9.

34. A non-transitory computer storage medium storing an executable program, wherein the executable program, when executed by a processor, causes the processor to implement the UE communication control method according to claim 9.
